(19) United States
(12) Patent Application Publication
(10) Pub. No.: US 2026/0078594 A1
(43) Pub. Date: Mar. 19, 2026

(54) INFLATABLE POOL WITH BOTTOM SHEET TENSIONING

(71) Applicant: BESTWAY INFLATABLES & MATERIAL CORP., Shanghai (CN)

(72) Inventor: Xianglin ZENG, Shanghai (CN)

(21) Appl. No.: 18/889,870

(22) Filed: Sep. 19, 2024

(30) Foreign Application Priority Data
Sep. 19, 2023 (CN) 202322552416.1

(51) Int. Cl. E04H 4/00

(52) U.S. Cl. CPC E04H 4/0025

(57) ABSTRACT

The present disclosure describes an inflatable pool. The inflatable pool includes an inner wall and an outer wall, which are connected along a first welding seam to form a first inflatable chamber; and a bottom sheet, which is connected to the outer wall along a second welding seam. The inflatable chamber and the bottom sheet define a water containing cavity. The present disclosure may effectively prevent wrinkling of the bottom sheet after the inflatable pool is inflated.

### CROSS REFERENCE TO RELATED APPLICATIONS

This Application claims priority from Chinese Application CN202322552416.1, filed Sep. 19, 2023 in China, the disclosure of which is incorporated herein by reference in its entirety for all purposes.

### FIELD AND BACKGROUND

### Field

The present embodiments relate to the field of above-ground pools, and particularly relate to an inflatable pool.

### Background

With the development of society, there is an increasing use of inflatable pools as entertainment products. Such inflatable pools are convenient to carry and easy to store. After these inflatable pools are inflated, a receiving space is formed by a side wall and a bottom sheet to store water, so that users may carry out entertainment activities in the pools.

The inflatable pools in the current market typically include multiple-ring pools such as two-ring pools and three-ring pools. In the prior art, a side wall of a toroidal inflatable pool includes an inner wall and an outer wall. The inner wall and the outer wall have the same length and are made of the same material. When the pool is in a fully inflated state, the outer wall, having a greater total surface area than the inner wall, is subjected to relatively more pressure than the inner wall, so that there is more stress inside the outer wall, and thus the outer wall reaches its elastic limits earlier than the inner wall. In contrast, the inner wall, having a smaller interior circumference than the larger outer circumference of the outer wall may stretch and expand inwardly more quickly than the outer wall expands in an outward direction, so that a welding position of the bottom sheet is driven to displace inwardly by a certain distance from its initial center position (between the inner wall and outer wall). As a result, the bottom sheet of the pool after inflation is wrinkled, thereby degrading the use experience of users, and affecting the aesthetics of the pool.

Specifically, FIGS. 1A to 1D show an inflatable three-ring pool 1A of the prior art. The illustrated pool 1A includes inflatable chambers 11A, 12A, and 13A that are formed by a folded weldable sheet material 9A (as shown in FIG. 1A1) and a bottom sheet 10A. In the illustrated prior art pool sections shown in FIG. 1A1, in order to increase the production efficiency, production personnel usually fold in half a single piece of rectangular weldable sheet material 9A (generally, a PVC material) to form the inner wall 14 and the outer wall 15, both of which are evenly distributed over a central vertical axis of symmetry 1105. Then also as shown in FIG. 1A, lower end portions of the inner wall 14 and the outer wall 15 are welded to each other at the lower welding position 1101A by high-frequency welding forming welding seams as discussed in more detail below (“welding seams” may also be known alternatively in some embodiments as “weld lines” or “welding lines”). Further, welding is carried out along two points at welding positions 1103A, 1104A, trisecting the inner wall 14 and the outer wall 15 of the folded weldable sheet material 9A, thereby forming three inflatable chambers 11A, 12A, 13A of the same size. The resulting inner wall segments 14A, 14B, 14C and the outer wall segments 15A, 15B, 15C of each respective inflatable chamber 11A, 12A, 13A have the same length. The weldable sheet material 9A that has welding seams 1101A, 1103A, 1104A, is then rolled so that remaining open ends of each inflatable chamber 14A, 14B, 14C abut one another and are respectively welded to one another to form a toroidal (donut-like) inflatable shape of the walls of the pool 1A. The bottom sheet 10A is welded at the bottom of the toroidal inflatable chambers 15A, 15B, 15C proximate the first welding seam 1101A.

More particularly, FIG. 1A illustrates a vertical sectional partial view of the prior art pool 1A in a deflated state. As shown in FIG. 1A, a sealed welding position of an inner wall 14 proximate first welding seam 1101A and an outer wall 15 of a bottommost toroidal inflatable chamber 11A is also a welding position of a bottom sheet 10A and the toroidal inflatable chamber 11A. That is, the inner wall 14, the outer wall 15 and the bottom sheet 10A are welded together at the same position to form a welding seam, or the welding position of the bottom sheet 10A and the toroidal inflatable chamber 11A is close to the sealed welding position at first welding seam 1101A of the inner wall 14 and the outer wall 15 of the bottommost toroidal inflatable chamber 11A.

FIG. 1B is a vertical sectional view of the pool 1A in an inflated state. As illustrated by a dashed contour in this figure, in an ideal state not shown in the prior art, each portion of the inner wall 14 (comprising segments 14A, 14B, 14C) and of the outer wall 15 (comprising segments 15A, 15B, 15C) of the toroidal inflatable chambers 11A, 12A, 13A would be subjected to a uniform expansion resulting from inflation, so that a position of the bottom welding point “e” would remain relatively immobile in the X direction and not translate outwardly or inwardly (as indicated by the arrow), and accordingly, the bottom sheet 10A would assume a flat state (not shown) upon inflation of the pool, as intended. However, in prior art implementations, as shown by a solid contour in this figure, the inner wall 14 and the outer wall 15 of the toroidal inflatable chambers 11A, 11B, 11C, which are made of the same material and have essentially the same perimeter in the deflated state, assume different topologies after inflation. More particularly, after inflation, the perimeter of the outer wall 15 becomes much greater than that of the inner wall 14 because of the toroidal shape assumed by the inflated chamber. Therefore, an internal stress of the outer wall 15 is much greater than that of the inner wall 14 due to the greater expansion required of the larger outer circumference outer wall as compared to smaller circumference inner wall, and due to material expansion limitations, the stretch and expansion of the outer wall 15 becomes more limited compared to the less-stressed and smaller circumference inner wall 14. In contrast, the inner wall 14, being confined to the smaller radius interior curves of the inflated toroidal chamber, has less internal stress from expansion forces and thus may deform more readily than the exterior wall 15. As a result, the bottom welding point “f” of the inner wall 14 and the outer wall 15 is shifted inwardly in a direction X toward the interior of the pool (from a point e to a point f in the figure), so that a peripheral portion of the bottom sheet is shifted inward by a certain distance. As such, as illustrated by wrinkled bottom 10A in FIG. 1B, and as shown schematically in the plan view of FIG. 1C, a diameter d1 of the circular welding seam 1101A upon inflation is smaller than an uninflated diameter d2 of the bottom sheet 10A, causing wrinkling of the bottom sheet 10A of the pool 1A after inflation (as shown in FIG. 1D), which affects the aesthetics of the pool and degrades the use experience of users (such as when the non-uniform pool bottom impinges on users'feet). Also, when the bottom sheet 10A has various patterns, the effect on the aesthetics from the wrinkled bottom sheet 10A is particularly noticeable.

### SUMMARY

The following summary is exemplary and explanatory only and is not necessarily restrictive of the claimed invention. The summary is intended to present general aspects of the present embodiments in order to provide a basic understanding of at least some salient features. This summary is not an extensive overview of all possible embodiments. It is not intended to identify key or critical elements of the present disclosure or to delineate the scope of all embodiments. The following summary merely presents some concepts of the embodiments in a general form as a prelude to the more detailed description provided below.

Further, it should be noted that in various embodiments, description is made with reference to figures, in which like reference numerals refer to similar or identical items in the drawings. However, certain embodiments may be practiced without one or more of these specifically identified details, or in combination with other known methods and configurations. In the following summary and detailed description, numerous details are set forth, such as specific configurations, dimensions and processes, etc., in order to provide a thorough understanding of the present invention. In other instances, well-known processes and conventional hardware have not been described in particular detail in order to not unnecessarily obscure the present embodiments. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment,” or the like in various places throughout this specification are not necessarily referring to the same embodiment of the invention. Furthermore, the particular features, structures, configurations, or characteristics may be combined in any suitable manner in one or more embodiments.

An objective of the present embodiments is to solve the problem of the occurrence of undesired wrinkles in a bottom sheet when a current inflatable pool is in an inflated state.

To solve the above-mentioned technical problem, the present embodiments describe an inflatable pool. The inflatable pool includes an inner wall and an outer wall connected to the inner wall along at least a first welding seam to form a first inflatable chamber, and a bottom sheet connected to the outer wall along a second welding seam.

In one aspect, the first inflatable chamber of the inflatable pool is toroidal after inflation and presents a circular cross section.

In another aspect, the second welding seam is placed outwardly of the inflatable pool with respect to a vertical axis of symmetry line of a cross section of the first inflatable chamber.

According to another specific technical solution of the present disclosure, the first inflatable chamber is toroidal after inflation, the first welding seam and the second welding seam form a central angle α on a circular cross section of the first inflatable chamber.

According to another specific technical solution of the present disclosure, the first inflatable chamber is toroidal after inflation and comprises a circular cross section having a vertical axis of symmetry; the first welding seam and the second welding seam form a central angle α on a circular cross section of the first inflatable chamber.

According to another specific technical solution of the present disclosure, the central angle α is comprised in a range between 5° and 32°, and in another implementation, in a range between 20° and 32°.

According to another specific technical solution of the present disclosure, the central angle α is one of 22 degrees, 24 degrees, 26 degrees, 28 degrees, or 30 degrees.

According to another specific technical solution of the present disclosure, the inner wall of the first inflatable chamber and the second wall of the first inflatable chamber comprise different materials.

According to another specific technical solution of the present disclosure, the inner wall of the first inflatable chamber and the second wall of the first inflatable chamber have differing Young's modulus values.

According to another specific technical solution of the present disclosure, a Young's modulus of the inner wall of the first inflatable chamber is greater than a Young's modulus of the outer wall of the first inflatable chamber.

According to another specific technical solution of the present disclosure, a tensioning member is disposed within the first inflatable chamber, an outer edge of the tensioning member is connected to the outer wall of the first inflatable chamber and inner edge of the tensioning member is connected to the outer wall of the first inflatable chamber proximate the second welding seam.

According to another specific technical solution of the present disclosure, the inner wall and the outer wall are formed by the same continuous flexible sheet material through bending.

According to another specific technical solution of the present disclosure, the inflatable pool comprises from one to five inflatable chambers, and for example, from two to three inflatable chambers, coupled one to another along respective welding seams.

According to one specific technical solution of the present disclosure, the inner wall of the first inflatable chamber and the outer wall of the first inflatable chamber have a same length during manufacturing.

According to this specific technical solution of the present disclosure, the first welding seam is placed at a distance from the second welding seam.

According to a second specific technical solution of the present disclosure, the length of the inner wall of the first inflatable chamber is greater than that the length of the outer wall of the first inflatable chamber during manufacturing.

According to this specific technical solution of the present disclosure, the first welding seam coincides with the second welding seam.

The positive and advanced effects of the present disclosure are as follows: for the pool, by changing a position of a junction of the chamber and an edge of the bottom sheet after inflation, the occurrence of a large number of wrinkles in the bottom sheet when the inflatable pool is in an inflated state is effectively prevented. In another embodiment, an internal tensioning member connected within the first inflatable chamber prevents undesired inward translation of the bottom sheet after inflation. In this way, the inflatable pool is more aesthetic and user friendly after inflation; accordingly, the user experience is improved.

Example embodiments may address at least the above problems and/or disadvantages and other disadvantages not described above. Also, example embodiments are not required to overcome the disadvantages described above, and may not overcome any of the problems described above.

### BRIEF DESCRIPTION OF THE DRAWINGS

The above and/or other aspects will become apparent and more readily appreciated from the following description of example embodiments, taken in conjunction with the accompanying drawings, in which:

FIG. 1A1 shows a partial cross-sectional view of unwelded components of a prior art inflatable three-ring pool before assembly;

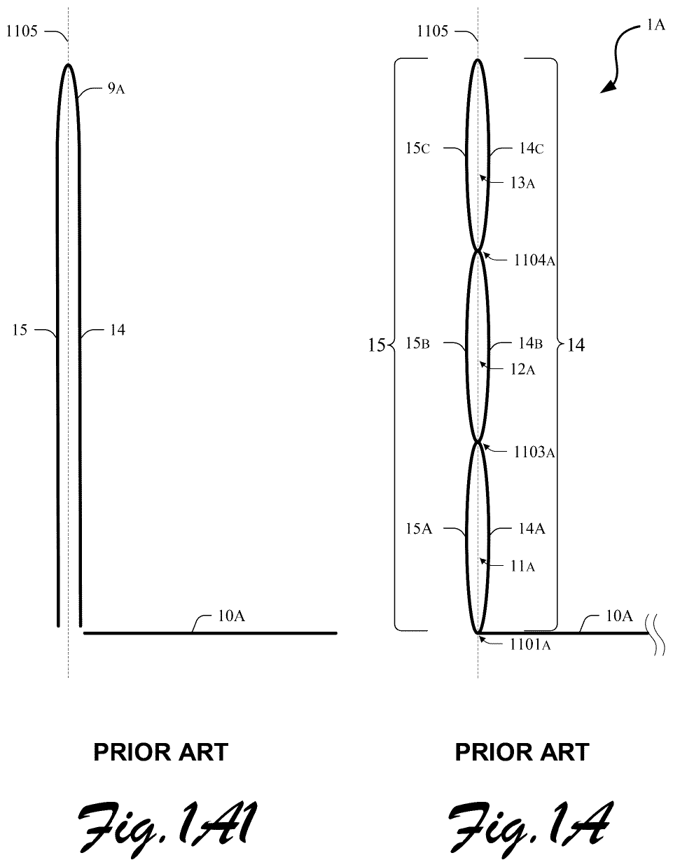

FIG. 1A shows a partial cross-sectional view of a prior art inflatable three-ring pool in a deflated state;

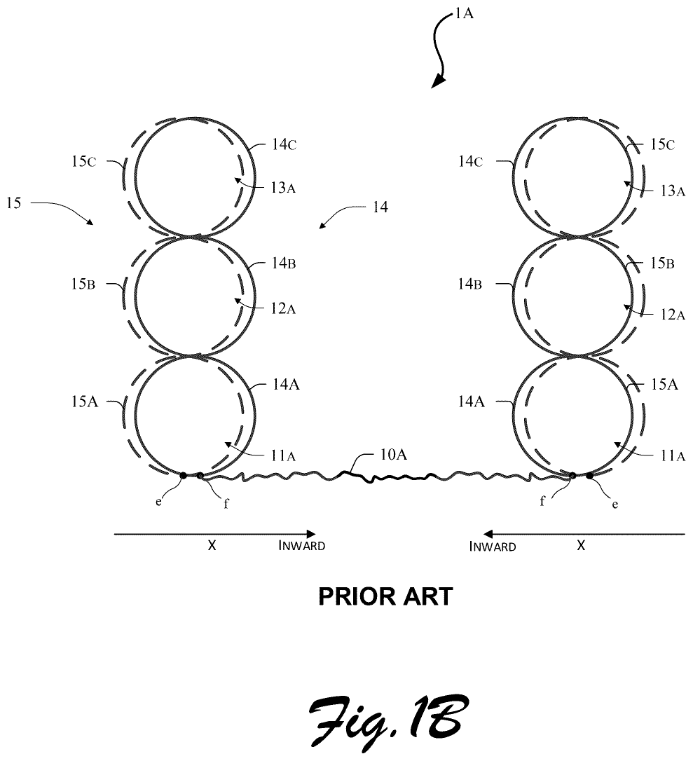

FIG. 1B shows a cross-sectional view of a prior art inflatable three-ring pool in an inflated state;

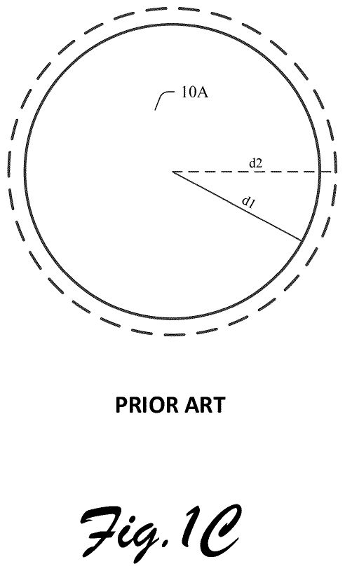

FIG. 1C shows a plan-view diagram of a change in a welding position of a prior art inflatable three-ring pool;

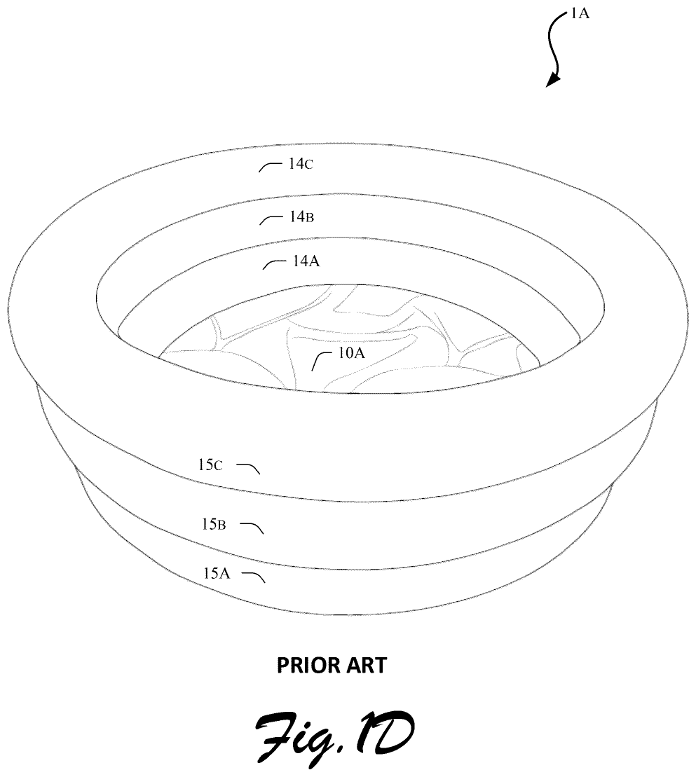

FIG. 1D shows a perspective view of a prior art inflatable three-ring pool in an inflated state;

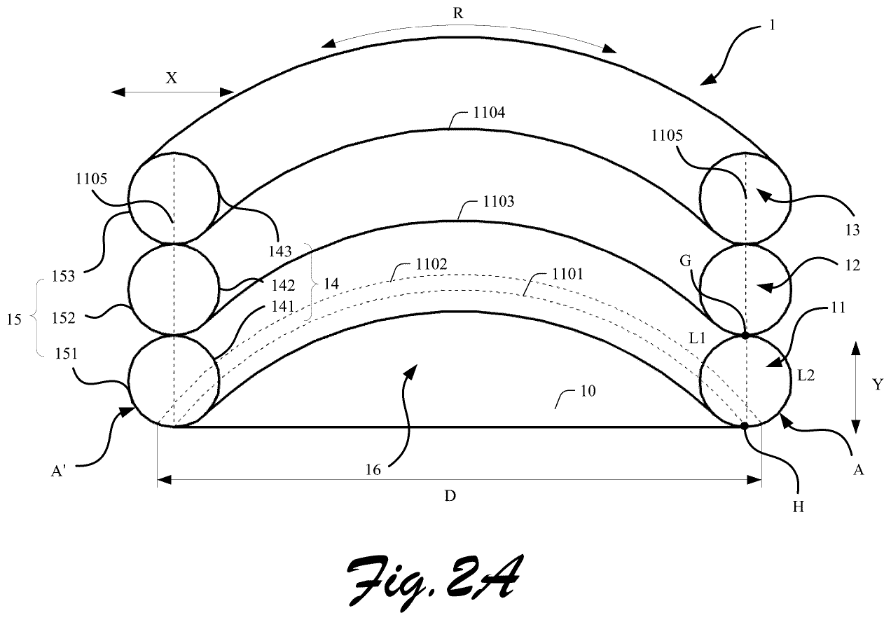

FIG. 2A shows a cross-sectional view of an inflatable pool according to embodiment 1 of the present disclosure;

FIG. 2B shows a detailed enlarged view of a section A′ in FIG. 2A;

FIG. 2C shows a perspective view of an inflatable pool according to embodiment 1 of the present disclosure;

FIG. 3A shows a cross-sectional view of an inflatable pool according to embodiment 2 of the present disclosure;

FIG. 3B shows an enlarged view of a section A′ in FIG. 3A;

FIG. 3C shows a perspective view of an inflatable pool according to embodiment 2 of the present disclosure;

FIG. 4A illustrates a perspective view of a tensioning member according to embodiment 3 of the present disclosure; and FIG. 4B shows a cross-sectional view of a first inflatable chamber further comprising a tensioning member according to embodiment 3 of the present disclosure.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

In the description, the expressions indicating orientations such as upper, lower, top, bottom, etc., which are used for describing the structural positions of various components, are not absolute but relative. The expressions indicating orientations are appropriate when the various components are arranged as shown in the figures, but should change accordingly when the positions of the components in the figures change.

In the description, unless expressly stated or limited otherwise, the terms such as “fixing”, “coupled,” “connection”, “connected”, etc. should be interpreted broadly, for example, either fixed or detachable connection, or integration; or may be a direct connection or an indirect connection by means of an intermediate medium, or may be communication between interiors of two elements or interaction between the two elements. For those skilled in the art, the specific meaning of the above terms in the description would have been understood according to specific circumstances.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Elements of example embodiments that are obvious to those of ordinary skill in the technical field to which these example embodiments pertain may not be described here in detail.

Implementations of the present disclosure are illustrated below by way of specific embodiments, and those skilled in the art would have readily understood other advantages and effects of the present disclosure from the content disclosed in the description. Although the description of the present disclosure will be introduced in conjunction with preferred embodiments, it does not mean that features of the present disclosure are limited to the implementations. On the contrary, an objective of introducing the present disclosure in conjunction with the implementations is to encompass other options or modifications that may be extended on the basis of the claims of the present disclosure. The following description contains numerous specific details in order to provide deep understanding of the present disclosure. The present disclosure may also be implemented without these details. In addition, in order to avoid confusing or obscuring key points of the present disclosure, some specific details will be omitted in the description. It should be noted that the embodiments and the features thereof in the present disclosure can be combined with each other without conflicts.

It should be noted that in the description, like reference signs and letters denote like items in the following drawings. Therefore, once an item is defined in one of the drawings, it is not necessary to further define and explain the item in the subsequent drawings.

In the description of the present embodiments, it should be noted that the orientation or position relationships indicated by the terms such as “upper”, “lower”, “inner,” “outer,” and “bottom” are based on the orientation or position relationships shown in the drawings or the orientation or position relationships in which a product of the present disclosure is customarily placed during use, and are only intended to facilitate description of the present disclosure and simplify the description, rather than indicating or implying that the apparatus or element indicated must have a specific orientation or be configured and operated in the specific orientation, and therefore cannot be construed as limiting the present disclosure.

The terms “first”, “second”, etc. are only intended to distinguish the description, and should not be construed as indicating or implying the relative importance.

In the description of the embodiments, it should also be noted that the terms “arrange”, “connected”, and “connection” should be understood in a broad sense, unless otherwise explicitly specified and limited. For example, the connection can be a secured connection, a detachable connection, or an integral connection; or may be a mechanical connection or an electrical connection; and can be directly connected, or indirectly connected by means of an intermediate medium, or communication between interiors of two elements. For those of ordinary skill in the art, the specific meaning of the terms mentioned above in the embodiments should be understood in specific cases.

In order to make objectives, technical solutions and advantages of the present disclosure clearer, the implementations of the present disclosure will be further described in detail below in conjunction with the drawings.

In order to solve the problem existing in the prior art, the present application provides embodiments as follows.

### Embodiment 1

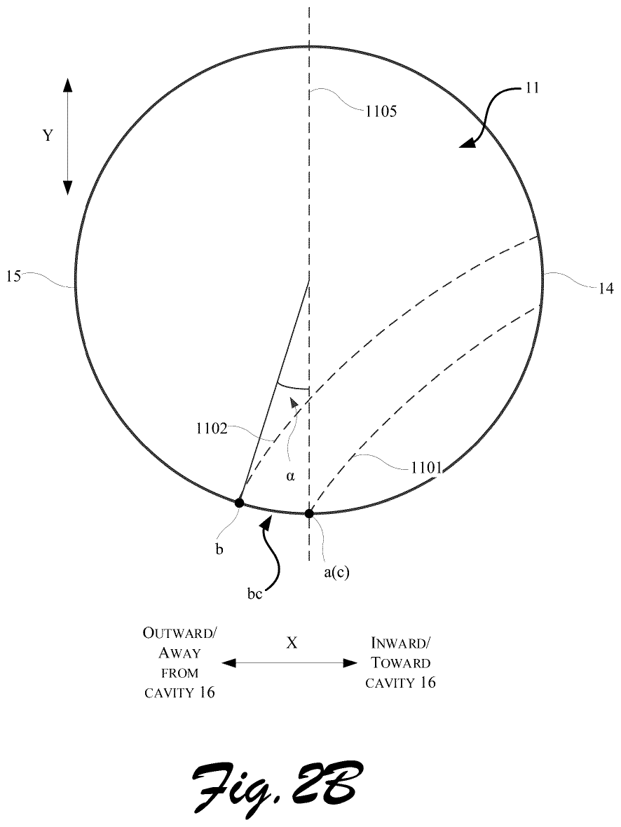

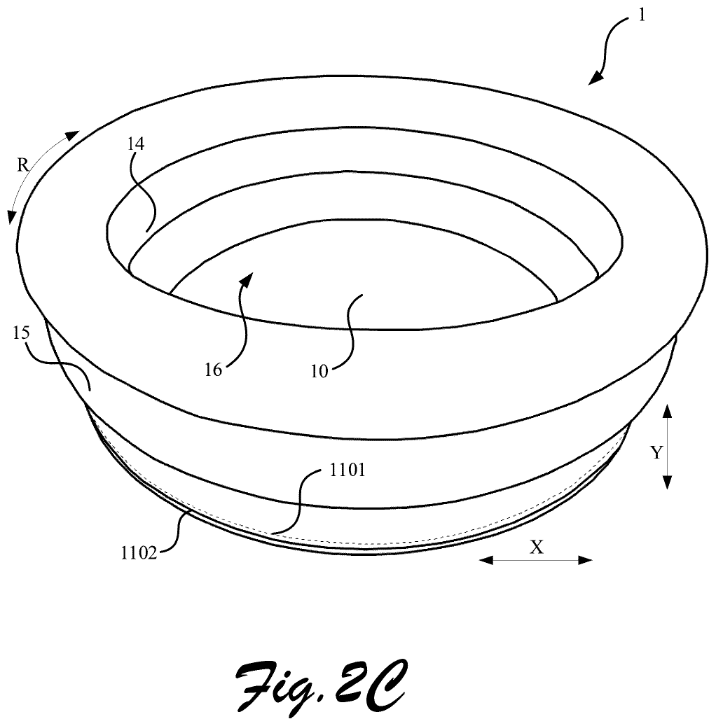

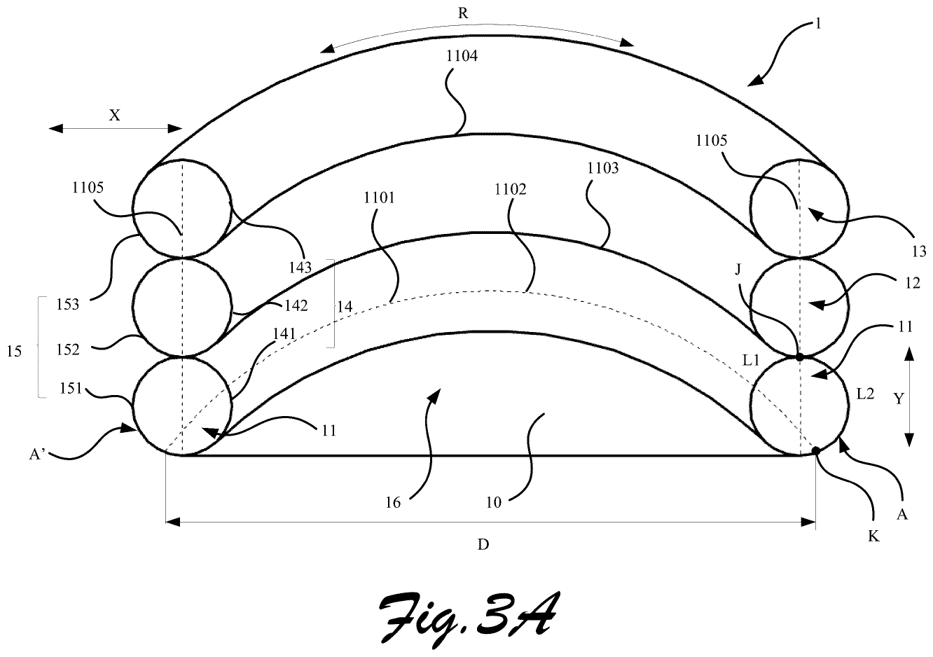

FIG. 2A shows a longitudinal cross-sectional view of an inflatable pool 1 shown with three toroidal rings according to the first exemplary embodiment, where the inflatable pool 1 is in an inflated state. The inflatable pool 1 includes an inner wall 14, an outer wall 15, and a bottom sheet 10. In one aspect, the inner wall 14 and the outer wall 15 both define the lateral wall of the pool, and the bottom sheet 10 defines the pool bottom. As shown in FIG. 2A, the outer wall 15 comprises a first outer wall 151, a second outer wall 152, and a third outer wall 153. Likewise, the inner wall 14 comprises a first inner wall 141, a second inner wall 142, and a third inner wall 143. In one implementation, the inner wall 14 and the outer wall 15 may be initially formed by the same continuous flexible sheet material through folding in half. In an alternative aspect, two different flexible sheet materials may be used, respectively, for the inner wall 14 and the outer wall 15, and such different flexible sheet materials may comprise different tensile stiffness/Young's modulus characteristics, and in one aspect, the material comprising the inner wall 14 may have a higher Young's modulus than the material comprising the outer wall 15. The inner wall 14 and the outer wall 15 may have the same length. In one aspect of this embodiment, the inner wall 14 and the outer wall 15 are created by folding a material sheet in half downward about a middle symmetrical position. Lower end portions of the inner wall 14 and the outer wall 15 are welded to each other to form a first welding seam 1101. The welding is also carried out along two further lines, therefore globally trisecting (therefore dividing in three equal parts) the inner wall 14 and the outer wall 15, to respectively form a third welding seam 1103 and a fourth welding seam 1104. In this embodiment, the inflatable chambers 11, 12, 13 have the same size. In one aspect, the third inner wall 143 and the third outer wall 153 meet at a top surface of the third inflatable chamber 13 proximate the axis of symmetry line 1105, just as the inner wall 14 and outer wall 15 meet in the same place via an initial fold line about axis line 1105. In alternate embodiments, welding is carried out on lines not necessarily trisecting the inner wall 14 and the outer wall 15, therefore forming inflatable chambers 11, 12, 13 of different sizes and/or to achieve different lengths of the inner wall 14 and the outer wall 15. In one implementation, each inflatable chamber 11, 12 and 13 presents a circular cross section A, A′. The side open ends (that is, the circular open ends of the inflatable chambers 11, 12, 13 shown in FIG. 2A) of the folded, welded sheet are brought together, with open ends abutting one another, and welding performed to seal ends of the first ring, second ring, and third ring together, respectively, thereby forming three toroidal inflatable chambers of the same or similar size, namely, a first inflatable chamber 11, a second inflatable chamber 12, and a third inflatable chamber 13. In one embodiment, the inner wall 14 and outer wall 15 may be welded to form different-sized inflatable chambers, and/or a different number of inflatable chambers than three chambers 11, 12, 13. The first inflatable chamber 11 includes a first inner wall 141 and a first outer wall 151. The periphery of the bottom sheet 10 and a location of the first outer wall 151 (as described in more detail below) are welded to form a second welding seam 1102. The bottom sheet 10 and the inner wall 14 define a space which comprises a water containing cavity 16.

As shown in FIG. 2A, the cross-sectional view of first inflatable chamber 11 includes two sections A′, A of the same size on the respective left and right sides of the figure, each having substantially similar cross sectional diameters to one another. Taking section A as an example, a cross-sectional aspect of the first inner wall 141 has a first arc length L1 (i.e., on one side proximate the water containing cavity 16 and of a portion between a point G and a point H for section A in FIG. 2A), and a cross-sectional aspect of the first outer wall 151 has a second arc length L2 (i.e., on one side facing away from the water containing cavity 16, therefore facing outwards, and of a portion between the point G and the point H for section A, in FIG. 2A). In the illustrated embodiment, first arc length L1 is approximately equal to the second arc length L2. Likewise, the second inflatable chamber 12 includes a second inner wall 142 and a second outer wall 152 of substantially the same length. The third inflatable chamber 13 includes a third inner wall 143 and a third outer wall 153 of substantially the same length.

FIG. 2B is an enlarged view of section A′ shown on the left side of the illustration in FIG. 2A. As shown in FIG. 2B, the first welding seam 1101 and the section A′ have a first intersection a, and the second welding seam 1102 and the section A′ have a second intersection b. In a vertical direction Y, section A′ includes a vertical axis of symmetry 1105. The axis of symmetry 1105 and the section A′ have a third intersection c. As shown in FIG. 2B, the first intersection a and the third intersection c are coextensive, and in a horizontal direction X, the second intersection b is located proximate the outer wall 15 in a position disposed distally from intersection c and the water containing cavity 16. The second intersection b and the third intersection c form an arc bc on the section A′. As shown in FIG. 2B, the arc bc subtends a central angle α. In one implementation, the central angle α may have a size of approximately 20 degrees. Put another way, a junction (i.e., the second welding seam 1102) of the bottom sheet 10 and the first inflatable chamber 11 is located on a side of the axis of symmetry 1105 in a direction disposed away from the water containing cavity 16 in the horizontal direction X.

In this exemplary embodiment, the junction (i.e., the second welding seam 1102) of the bottom sheet 10 and the first inflatable chamber 11 is arranged on one side of the axis of symmetry 1105 distally (outwardly) removed from the water containing cavity 16 in the horizontal direction X. As the first inflatable chamber 11 is inflated, due to the toroidal shape of the chamber 11, the outer wall 15, with its larger outer circumference, experiences higher rate of differential strain compared to the smaller inner circumference of the inner wall 14, and thus the outer wall 15 reaches its elastic limit before the inner wall 14. Accordingly, as the first inflatable chamber 11 is inflated, the first welding seam 1101 is driven to shift toward the interior of the pool by a certain distance, while the second welding seam 1102 approaches the third intersection c or remains on the side of the axis of symmetry 1105 away from the water containing cavity 16 in the horizontal direction X (as shown in FIG. 2C). Therefore, the tension resulting from the bottom sheet 10 to outer wall 15 welding seam 1102 (at point b) being driven outwardly with respect to line of symmetry 1105 results in an outward tensioning force being applied to the bottom sheet 10, and accordingly the bottom sheet 10 is fully expanded as a preset shape, thereby avoiding wrinkling, which ensures the aesthetics of the inflatable pool 1, and improves the user experience. In other words, the bottom sheet 10 is connected to the outer wall 15 of the first inflatable chamber 11, at a location of the first outer wall 151 positioned outwardly of the pool with respect to the vertical axis of symmetry line 1105 of a cross section A or A′ of the first inflatable chamber 11. Therefore, the welding seam 1102 (more generically called the junction) connecting the bottom sheet 10 to the outer wall 15 of the first inflatable chamber 11 is positioned outwardly with respect to the vertical axis of symmetry line 1105 of a circular cross section A, A′ of the first inflatable chamber 11 (therefore positioned towards the external part of the pool).

A material used for the inner wall 14, the outer wall 15, and the bottom sheet 10 is not specifically limited. In this embodiment, the material may comprise polyvinyl chloride (PVC), or thermoplastic polyurethane elastomer (TPU). As stated above, materials used for the inner wall 14 and outer wall 15 may differ, and may respectively possess different stiffness or Young's modulus characteristics. In one embodiment, the material used for the inner wall 14 has a higher Young's modulus than the material comprising the outer wall 15.

The junction (i.e., the second welding seam 1102) of the bottom sheet 10 and the first inflatable chamber 11 may be adjusted according to specific situations. In various implementations, the central angle α in this embodiment may range from 20 to 32 degrees; for example, central angle α may be selected with exemplary values of 22 degrees, 24 degrees, 26 degrees, 28 degrees, or 30 degrees. Those of skill in the art appreciate that any desired angle may be selected to place the second welding seam 1102 at any desired location on the external wall 15 to achieve a uniform, unwrinkled appearance of the pool bottom 10.

Although illustrated with three inflatable chambers, the number of inflatable chambers included in the inflatable pool 1 is not specifically limited. In one exemplary aspect, there may be one to five inflatable chambers in the inflatable pool 1, and in various implementations, the inflatable pool may include two or three inflatable chambers.

### Embodiment 2

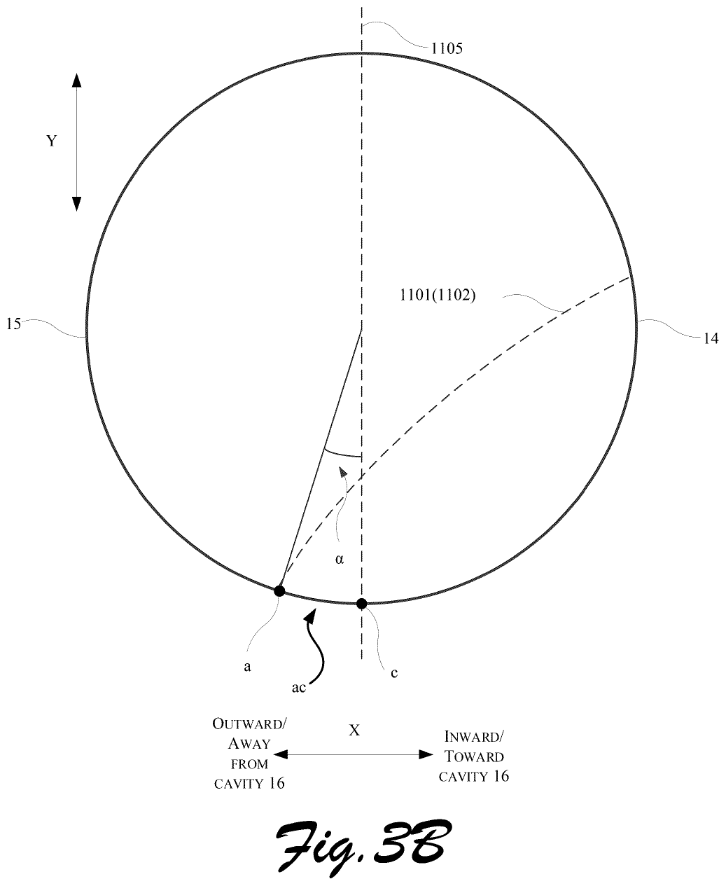

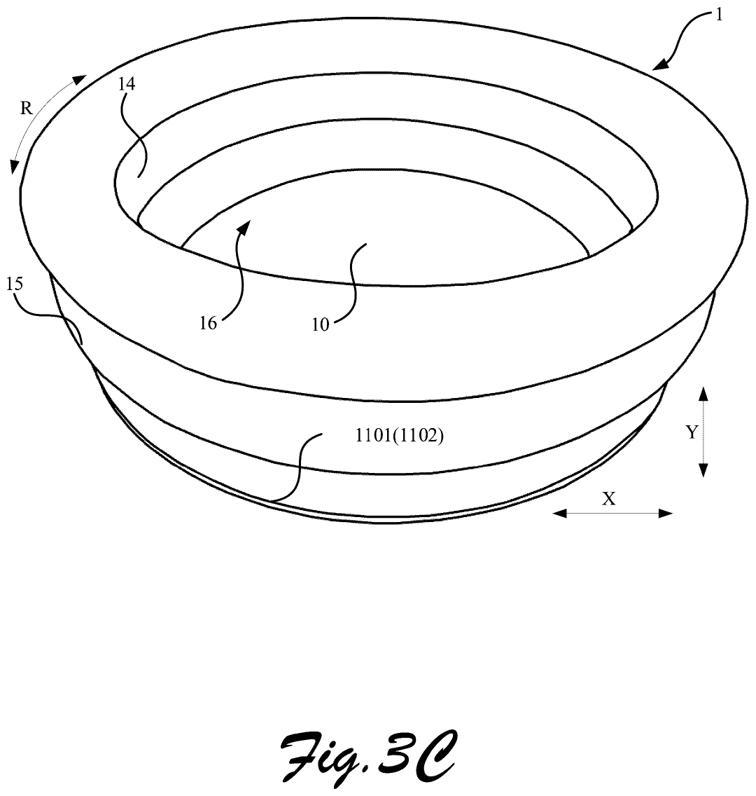

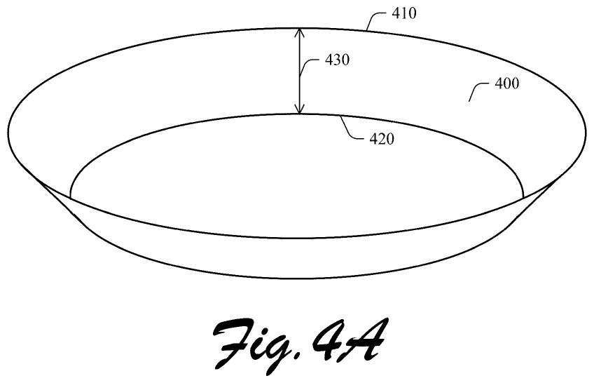

FIG. 3A shows a longitudinal cross-sectional view of an inflatable pool 1 with three rings according to the second exemplary embodiment, where the inflatable pool 1 is in an inflated state. The inflatable pool 1 includes an inner wall 14, an outer wall 15, and a bottom sheet 10. In one aspect, the inner wall 14 and the outer wall 15 both define the lateral wall of the pool, and the bottom sheet 10 defines the pool bottom. As shown in FIG. 3A, the outer wall 15 comprises a first outer wall 151, a second outer wall 152, and a third outer wall 153. Likewise, the inner wall 14 comprises a first inner wall 141, a second inner wall 142, and a third inner wall 143. In one implementation, the inner wall 14 and the outer wall 15 may be initially formed by the same continuous flexible sheet material through bending. In an alternative aspect, two different flexible sheet materials may be used, respectively, for the inner wall 14 and the outer wall 15, and such different flexible sheet materials may comprise different tensile stiffness/Young's modulus characteristics, and in one aspect, the material comprising the inner wall 14 may have a higher Young's modulus than the material comprising the outer wall 15. The inner wall 14 and the outer wall 15 have different lengths. A lower end portion of the inner wall 14, a lower end portion of the outer wall 15, a peripheral portion of the bottom sheet 10 are welded to one another to form a first welding seam 1101. The welding is also carried out on a portion between upper end portions of the inner wall 14 and of the outer wall 15 and between lower end portions of the inner wall 14 and of the outer wall 15, to form a third welding seam 1103 and a fourth welding seam 1104. In this way, three toroidal inflatable chambers of approximately the same size are formed, namely, a first inflatable chamber 11, a second inflatable chamber 12, and a third inflatable chamber 13. That is, in this embodiment, a second welding seam 1102 formed at a junction of the bottom sheet 10 and the first inflatable chamber 11 coincides with the first welding seam 1101. In one implementation, each inflatable chamber 11, 12 and 13 presents a circular cross section A, A′. During the assembly process, the open ends of the inflatable chambers 11, 12 13 of the welded sheet are approximated, with open ends abutting one another, and welding performed to seal respective ends of the first ring (corresponding to the first inflatable chamber 11), second ring (corresponding to the second inflatable chamber 12), and third ring (corresponding to the third inflatable chamber 13) together to further define inflatable chambers 11, 12, and 13. As a result of the aforementioned assembly process, the bottom sheet 10 and the inner wall 14 define a space which comprises a water containing cavity 16.

As shown in FIG. 3A, the first inflatable chamber 11 includes a first inner wall 141 and a first outer wall 151, the second inflatable chamber 12 includes a second inner wall 142 and a second outer wall 152, and the third inflatable chamber 13 includes a third inner wall 143 and a third outer wall 153. The second inner wall 142 and the second outer wall 152, and the third inner wall 143 and the third outer wall 153 all have approximately the same size.

Continuing to refer to FIG. 3A, the first inflatable chamber 11 includes two sections A′, A of the same size on the respective left and right sides of the figure, each having substantially similar cross sectional diameters to one another. Taking section A as an example, a cross-sectional aspect of the first inner wall 141 has a first arc length L1 (i.e., on one side proximate the water containing cavity 16 and of a portion between a point J and a point K for section A in FIG. 3A), and a cross-sectional aspect of the first outer wall 151 has a second arc length L2 (i.e., on one side facing away from the water containing cavity 16 and of a portion between the point J and the point K for section A, in FIG. 3A), the first arc length L1 being greater than the second arc length L2.

FIG. 3B is an enlarged view of section A′ on the left side of the illustration in FIG. 3A. As shown in FIG. 3B, the first welding seam 1101 (coinciding with the second welding seam 1102) and the section A′ have a first intersection a. In a vertical direction Y, the section A′ includes a vertical axis of symmetry 1105. The axis of symmetry 1105 and the section A′ have a third intersection c. As shown in FIG. 3B, in a horizontal direction X (orthogonal to the axis of symmetry 1105), the first intersection a is on one side of the third intersection c disposed in an outward direction away from the water containing cavity 16. The first intersection a and the third intersection c form an arc ac on the section A′. As shown in FIG. 3B, the arc ac subtends a central angle α. In one implementation, the central angle α has a size of approximately 32 degrees. Put another way, a junction (i.e., the second welding seam 1102 or the coincident first welding seam 1101) of the bottom sheet 10 and the first inflatable chamber 11 is located on one side of the axis of symmetry 1105 in a direction disposed away from the water containing cavity 16 in the horizontal direction X.

In this exemplary embodiment, the junction (i.e., the second welding seam 1102 or the coincident first welding seam 1101) of the bottom sheet 10 and the first inflatable chamber 11 is arranged on one side of the axis of symmetry 1105 distally (outwardly) removed from the water containing cavity 16 in the horizontal direction X. As the first inflatable chamber 11 is inflated, due to the toroidal shape of the chamber 11, the outer wall 15, with its larger outer circumference, experiences higher rate of differential strain compared to the smaller inner circumference of the inner wall 14, and thus the outer wall 15 reaches its elastic limit before the inner wall 14. Accordingly, as the first inflatable chamber 11 is inflated, the first welding seam 1101 (coinciding with the second welding seam 1102) is driven to shift toward the interior of the pool by a certain distance: in the final inflated state, the first welding seam 1101 (coinciding with the second welding seam 1102) arrives, at the most, to coincide with the third intersection c or remains on the side of the axis of symmetry 1105 away from the water containing cavity 16 in the horizontal direction X (as shown in FIG. 3C). Therefore, the tension resulting from the bottom sheet to outer wall 15 welding seam 1102 (at point a) being driven outwardly with respect to line of symmetry 1105 results in an outward tensioning force being applied to the bottom sheet 10, and accordingly the bottom sheet 10 is fully expanded at a preset position, thereby avoiding wrinkling, which ensures the aesthetics of the inflatable pool 1, and improves the user experience. Also in this second embodiment, the bottom sheet 10 is connected to the outer wall 15 of the first inflatable chamber 11, at a location of the first outer wall 151 positioned outwardly of the pool with respect to the vertical axis of symmetry line 1105 of a cross section A or A′ of the first inflatable chamber 11. Therefore, the welding seam 1101, 1102 (more generically called the junction) connecting the bottom sheet 10 to the outer wall 15 of the first inflatable chamber 11 is positioned outwardly with respect to the vertical axis of symmetry line 1105 of a circular cross section A, A′ of the first inflatable chamber 11 (therefore positioned towards the external part of the pool).

A material used for the inner wall 14, the outer wall 15, and the bottom sheet 10 is not specifically limited. In this embodiment, the material may comprise polyvinyl chloride (PVC), or thermoplastic polyurethane elastomer (TPU).

The junction (i.e., the first welding seam 1101 coinciding with the second welding seam 1102) of the bottom sheet 10 and the first inflatable chamber 11 may be adjusted according to specific situations. In one aspect, the central angle α in this embodiment is in a range of 20 to 32 degrees; for example, the central angle α may be selected with exemplary values of 22 degrees, 24 degrees, 26 degrees, 28 degrees, or 30 degrees. Those of skill in the art appreciate that any desired angle may be selected to place the second welding seam 1102 at any desired location on the outer wall 15 to achieve a uniform, unwrinkled appearance of the pool bottom 10.

The number of inflatable chambers included in the inflatable pool 1 is not specifically limited. In one aspect, the inflatable pool 1 may include number of inflatable chambers in in the range of one to five, or in another implementation, the inflatable pool 1 may include two or three inflatable chambers.

### Embodiment 3

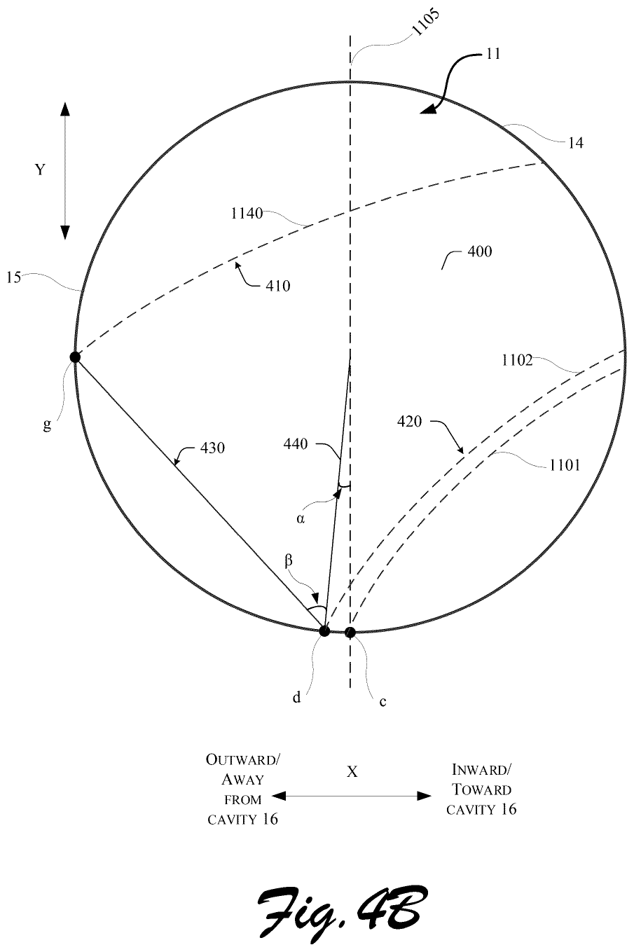

FIGS. 4A-4B show exemplary third embodiments of an inflatable pool 1 (according to refinements of embodiment 1 or embodiment 2) further comprising an additional tensioning member 400. Referring to FIG. 4A, a tensioning member 400 is shown in the geometric configuration of a slice of a conic section, has an outside edge 410, an inside edge 420, and a length 430. The tensioning member 400 may comprise a flexible, weldable material; for example, the tensioning member 400 may comprise polyvinyl chloride (PVC), fiber-reinforced PVC, or thermoplastic polyurethane elastomer (TPU) materials.

FIG. 4B further illustrates a left-side cross-sectional view of the first inflatable chamber 11 of the inflatable pool 1 similar to sections A′ of FIG. 2B of the first embodiment, and can also apply to the second embodiment of section A′ shown in FIG. 3B. FIG. 4B shows the tensioning member 400 of FIG. 4A when situated and connected within the first inflatable chamber 11 between illustrated points g and d at side welding seam 1140 (along the outer wall 15) and second welding seam 1102, respectively. Such connections may be achieved by welding or through application of adhesives. In various embodiments, first welding seam 1101 and second welding seam 1102 may coincide, or second welding seam 1102 may be disposed in an outward direction X from first welding seam 1101. In detail, the tensioning member 400 is disposed within the first inflatable chamber 11, connecting both the outer edge (outside edge) 410 and the inner edge (inside edge) 420 to the outer wall 15 of the first inflatable chamber 11. The junction (i.e., the second welding seam 1102) of the bottom sheet 10 and the first inflatable chamber 11 may be adjusted according to specific situations. For example, in the present embodiment, the central angle α is formed between the second welding seam 1102 and the vertical axis of symmetry 1105 of the section A or A′ of the inflatable chamber 11; the central angle α in this embodiment, subtended by arc cd (or measured between the reference line 440 and the central vertical axis of symmetry 1105), may be in a range of 0 to 20 degrees; for example, the central angle α may comprise 0 degrees, 5 degrees, 10 degrees, 15 degrees, or 20 degrees. Further, a junction between the side welding seam 1140 and the outer wall 15 of the first inflatable chamber 11 may be adjusted according to specific characteristics with respect to the angle β between reference line 440 and the tensioning member 400, which may range in various implementations from 28 degrees to 64 degrees or from 20 degrees to 75 degrees; for example, the angle β may comprise 30 degrees, 40 degrees, 50 degrees, or 60 degrees. In one exemplary configuration shown in FIG. 4B, angle α is approximately 5 degrees and angle β is approximately 48 degrees. The presence of a further welding seam (side welding seam 1140) placed on the outer wall 15 and further connecting the outer wall 15 to the bottom sheet 10 through the tensioning member 400 (in detail through the length 430 of the tensioning member 400), allows to reduce the width of the central angle α. Also in this third embodiment, the bottom sheet 10 is connected to the outer wall 15 of the first inflatable chamber 11, at a location of the first outer wall 151 positioned outwardly of the pool with respect to the vertical axis of symmetry line 1105 of a circular cross section A or A′ of the first inflatable chamber 11.

Generally, as discussed above, when the first inflatable chamber 11 is pressurized to assume an inflated state, the outer wall 15 expands outwardly in a direction X, away from the cavity 16. As a result of this expansion, the tensioning member 400 is pulled by the expanding outer wall 15 in an outward (X) and upward (Y) direction, resulting in tensile forces being transmitted from the outer wall 15 through the outside edge 410 of the tensioning member 400 to the inside edge 420 of the tensioning member 400, and accordingly, the tensile forces pull a bottom area of the first inflatable chamber 11 (proximate point d) in an outward (X) direction. As the tensile force urges a bottom portion of the inflatable chamber (proximate letter d and/or c) toward an outward direction X, such force prevents a bottom area (proximate letter d and/or c) from shifting inwardly in an X direction toward the cavity 16 during inflation; accordingly, an attached bottom sheet 10, welded as described above in regards to embodiments 1 and 2, will be pulled taut and will maintain the desirable flat and wrinkle-free configuration.

Although the present disclosure has been illustrated and described with reference to some preferred implementations of the present disclosure, those of ordinary skill in the art should understand that the above contents are further detailed descriptions for the present disclosure in conjunction with specific implementations, and it cannot be assumed that the specific implementations of the present disclosure are limited to these descriptions. Those skilled in the art can make various changes in form and details, including several simple deduction or substitutions, without departing from the sprit and scope of the present disclosure.

It can be understood that the welding methods mentioned in the description comprise high-frequency welding, hot-press welding and any other suitable welding methods.

It can also be understood that the components and features described herein can be made of various other materials including, but not limited to, polymers, rubber, metal, and other suitable materials well known to those skilled in the art or a combination thereof. The described and illustrated embodiments only show the shapes, dimensions and arrangements of various optional components of the inflatable pad according to the present disclosure, which are merely illustrative but not limiting, and other shapes, dimensions and arrangements may be employed without departing from the spirit and scope of the present disclosure. Those skilled in the art can easily make modifications, variations, and equivalents of these embodiments on the basis of the disclosed content. For example, the illustrated or described features as part of an embodiment can be used with another embodiment to provide a further embodiment. The present disclosure is intended to cover these modifications, variations, and equivalents.

It should be understood that the example embodiments described herein may be considered in a descriptive sense only and not for purposes of limitation. Descriptions of features or aspects within each example embodiment may be considered as available for other similar features or aspects in other example embodiments. While example embodiments have been described with reference to the figures, it will be understood by those of ordinary skill in the art that various changes in form and details may be made therein without departing from the scope as defined by the following claims.

What is claimed is:

1. An inflatable pool, comprising:
an inner wall;
an outer wall connected to the inner wall along at least a first welding seam to form a first inflatable chamber; and
a bottom sheet connected to the outer wall along a second welding seam.

2. The inflatable pool according to claim 1, wherein the first inflatable chamber is toroidal after inflation and presents a circular cross section; the second welding seam being placed outwardly of the inflatable pool with respect to a vertical axis of symmetry line of a cross section of the first inflatable chamber.

3. The inflatable pool according to claim 1, wherein the first inflatable chamber is toroidal after inflation, the first welding seam and the second welding seam form a central angle α on a circular cross section of the first inflatable chamber.

4. The inflatable pool according to claim 3, wherein the central angle α is in a range between:
5 degrees and 32 degrees; or
20 degrees and 32 degrees.

5. The inflatable pool according to claim 3, wherein the central angle α is one of 22 degrees, 24 degrees, 26 degrees, 28 degrees, or 30 degrees.

6. The inflatable pool according to claim 1, wherein:
the first inflatable chamber is toroidal after inflation and comprises a circular cross section having a vertical axis of symmetry;
the second welding seam and the vertical axis of symmetry line form a central angle α on the circular cross section of the inflatable chamber.

7. The inflatable pool according to claim 6, wherein the central angle α is in a range between:
5 degrees and 32 degrees, or
20 degrees and 32 degrees.

8. The inflatable pool according to claim 6, wherein the central angle α is one of 22 degrees, 24 degrees, 26 degrees, 28 degrees, or 30 degrees.

9. The inflatable pool according to claim 1, wherein the inner wall of the first inflatable chamber and the second wall of the first inflatable chamber comprise different materials.

10. The inflatable pool according to the claim 9, wherein the inner wall of the first inflatable chamber and the second wall of the first inflatable chamber have differing Young's modulus values.

11. The inflatable pool according to claim 10, wherein a Young's modulus of the inner wall of the first inflatable chamber is greater than a Young's modulus of the outer wall of the first inflatable chamber.

12. The inflatable pool according to claim 1, wherein the inner wall of the first inflatable chamber and the outer wall of the first inflatable chamber have a same length during manufacturing.

13. The inflatable pool according to claim 1, wherein the first welding seam is placed at a distance removed from the second welding seam.

14. The inflatable pool according to claim 1, wherein the length of the inner wall of the first inflatable chamber is greater than that the length of the outer wall of the first inflatable chamber during manufacturing.

15. The inflatable pool according to claim 1, wherein the first welding seam coincides with the second welding seam.

16. The inflatable pool according to claim 1, wherein the inner wall and the outer wall are formed by the same continuous flexible sheet material through bending.

17. The inflatable pool according to claim 1, further comprising a tensioning member disposed within the first inflatable chamber, an outer edge of the tensioning member connected to the outer wall of the first inflatable chamber and inner edge of the tensioning member connected to the outer wall of the first inflatable chamber proximate the second welding seam.
